(19) United States
(12) Patent Application Publication
(10) Pub. No.: US 2013/0071754 A1
(43) Pub. Date: Mar. 21, 2013

(54) ELECTRODE BODY AND SECONDARY BATTERY USING SAME

(71) Applicants: Hidenori Miki, Mishima-shi (JP); Hideki Oki, Susono-shi (JP)

(72) Inventors: Hidenori Miki, Mishima-shi (JP); Hideki Oki, Susono-shi (JP)

(73) Assignee: TOYOTA JIDOSHA KABUSHIKI KAISHA, Toyota-shi (JP)

(21) Appl. No.: 13/520,447

(22) PCT Filed: Apr. 30, 2010
(86) PCT No.: PCT/JP2010/057677

§ 371 Date: Jul. 3, 2012

(51) Int. Cl. H01M 4/485; H01M 4/62

(52) U.S. Cl. CPC H01M 4/485; H01M 4/626
USPC 429/232; 429/209; 252/521.5; 252/518.1; 252/520.21

(57) ABSTRACT

A main object of the present invention is to provide an electrode body which can obtain a high capacity secondary battery. The invention provides an electrode body having an active material composed of a metal oxide and a conductive auxiliary agent obtained by causing a partial deficiency to an oxygen atom in the metal oxide and introducing a nitrogen atom into the metal oxide, whereby the above object can be achieved.

### TECHNICAL FIELD

The present invention relates to an electrode body which can obtain a high capacity secondary battery.

### BACKGROUND ART

In order to improve the performance of a secondary battery, a lot of ideas have been conventionally devised in an active material and a conductive auxiliary agent constituting an electrode body of the secondary battery.

For example, Patent Literature 1 discloses an electrode body using, as an active material of a Li-ion battery, a material obtained by treating TiO₂ with heat in NH₃ and replacing oxygen atoms by nitrogen. In the Li-ion battery, the internal resistance of the active material can be reduced. Patent Literature 2 discloses an active material whose electron conductivity is improved by treating TiO₂ with heat in an Ar atmosphere containing hydrogen, ammonia, and carbon monoxide and thereby introducing an oxygen atom deficiency. When the electrode body is formed of only an active material, sufficient electron conductivity cannot be obtained, and therefore, a carbon-based material having electron conductivity is added as a conductive auxiliary agent and it thereby contributes to the improvement in the electron conductivity.

### CITATION LIST

### Patent Literature

Patent Literature 1: Japanese Patent Application Laid-Open No. 2006-032321

Patent Literature 2: Japanese Patent Application Laid-Open No. 2005-340078

### SUMMARY OF INVENTION

### Technical Problem

In the active material disclosed in the Patent Literature 1, although the electron conductivity is improved by introduction of nitrogen, the capacity is reduced, and therefore, increase in the capacity of the secondary battery cannot be expected. In addition, in the active material disclosed in the Patent Literature 2, even though the electron conductivity is increased to approximately 10⁻⁶ S/cm by introducing only an oxygen atom deficiency, the capacity is highly likely to be lowered. Further, regarding the carbon-based material, although it has the electron conductivity, it does not have a lithium ion conductivity; therefore, when the carbon-based material is used as a conductive auxiliary agent, a lithium ion conductive path in an electrode body is cut, and the capacity may be reduced. Since the carbon-based material does not contribute to a capacitive component of the secondary battery, when the carbon-based material is used as the conductive auxiliary agent, the capacity of the secondary battery is reduced.

In view of the above circumstances, a main object of the present invention is to provide an electrode body which can obtain a high capacity secondary battery.

### Solution to Problem

In order to achieve the above object, the present invention provides an electrode body comprising: an active material composed of a metal oxide; and a conductive auxiliary agent obtained by causing a partial deficiency to an oxygen atom in the metal oxide and introducing a nitrogen atom into the metal oxide.

According to the present invention, since the conductive auxiliary agent is obtained by causing a partial deficiency to an oxygen atom in the metal oxide constituting the active material and introducing a nitrogen atom into the metal oxide, the conductive auxiliary agent has a lithium ion conductivity and an electron conductivity. According to this constitution, in a secondary battery using the electrode body, the capacity can be increased.

The present invention further provides an electrode body comprising: an active material; and a conductive auxiliary agent composed of a conductive metal oxide with an electron conductivity of 10⁻⁴ S/cm or more.

According to the present invention, the conductive auxiliary agent has a lithium ion conductivity and a high electron conductivity as described above. According to this constitution, in a secondary battery using the electrode body, the capacity can be increased.

In the present invention, it is preferable that the active material is composed of a metal oxide, and the conductive metal oxide is obtained by causing a partial deficiency to an oxygen atom in the metal oxide and introducing a nitrogen atom into the metal oxide. This is because in a secondary battery using the electrode body, the capacity can be effectively increased.

In the present invention, the metal oxide is preferably Li₄Ti₅O₁₂. This is because in the secondary battery using the electrode body, the capacity can be more effectively increased.

The present invention furthermore provides a conductive auxiliary agent for secondary battery, obtained by causing a partial deficiency to an oxygen atom in Li₄Ti₅O₁₂ and introducing a nitrogen atom into Li₄Ti₅O₁₂, and having an electron conductivity of 10⁻⁴ S/cm or more.

According to the present invention, the conductive auxiliary agent for secondary battery has the lithium ion conductivity and the high electron conductivity described above. Consequently, in a secondary battery using the conductive auxiliary agent for secondary battery in the electrode body, the capacity can be increased.

The present invention furthermore provides a secondary battery in which the electrode body is used in at least one of a cathode layer and an anode layer.

According to the present invention, in the secondary battery, since the electrode body is used, the capacity can be increased.

### Advantageous Effects of Invention

The present invention provides such an effect that an electrode body realizing the increase in capacity can be provided.

### BRIEF DESCRIPTION OF DRAWINGS

FIG. 1 is a schematic cross-sectional view showing an electrode body having an aspect (aspect A) in which particles of an active material and particles of a conductive auxiliary agent are mixed.

FIG. 2 is a schematic cross-sectional view showing an electrode body having an aspect (aspect B) in which a coat of the conductive auxiliary agent is formed on a surface of the particles of the active material.

FIG. 3 is a schematic cross-sectional view showing the aspect (aspect B) in which the coats of the conductive auxiliary agent are formed on some portion of the surface of the particles of the active material.

FIG. 4 is a schematic cross-sectional view showing the aspect (aspect B) in which the coat of the conductive auxiliary agent is formed on the entire surface of the particles of the active material.

FIG. 5 is a schematic cross-sectional view showing an electrode body having an aspect (aspect C) in which the surface of the particles of the active material is altered to the conductive auxiliary agent, and an alterated layer of the conductive auxiliary agent is formed.

FIG. 6 is a schematic cross-sectional view showing the electrode body having the aspect (aspect C) in which the surface of the particles of the active material is altered to the conductive auxiliary agent, and the alterated layer of the conductive auxiliary agent is formed.

FIG. 7 is a schematic cross-sectional view showing an example of a secondary battery.

FIG. 8 is a graph showing results of charge and discharge characteristics of an all-solid-state secondary battery manufactured in an example 1, an example 2, and a comparative example 1.

FIG. 9 is a graph showing an XRD measurement result of a sample of an example 3.

FIG. 10 is a graph showing the XRD measurement result of the sample of the example 3.

FIG. 11 is a graph showing results of evaluation of the charge and discharge characteristics of the sample of the example 3.

FIG. 12 is a graph showing results of evaluation of the charge and discharge characteristics of a sample of an example 4.

### DESCRIPTION OF EMBODIMENTS

Hereinafter, an electrode body and a secondary battery using a conductive auxiliary agent for secondary battery and the electrode body will be described in detail.

### A. Electrode Body

First, the electrode body of the present invention will be described. The electrode body of the present invention can be classified into two embodiments. One (first embodiment) comprises an active material composed of a metal oxide and a conductive auxiliary agent obtained by causing a partial deficiency to oxygen atoms in the metal oxide and introducing nitrogen atoms into the metal oxide, and the other (second embodiment) comprises an active material and a conductive auxiliary agent composed of a conductive metal oxide with an electron conductivity of 10⁻⁴ S/cm or more. Hereinafter, in each embodiment, the electrode body of the present invention will be described in detail.

### 1. First Embodiment

An electrode in the present embodiment comprises an active material composed of a metal oxide and a conductive auxiliary agent obtained by causing a partial deficiency to oxygen atoms in the metal oxide and introducing nitrogen atoms into the metal oxide.

According to the present embodiment, the conductive auxiliary agent is obtained by causing a partial deficiency to oxygen atoms in the metal oxide and introducing the nitrogen atoms into the metal oxide. Thus, the conductive auxiliary agent has an electron conductivity, a lithium ion conductivity, and a capacity. Since the respective charge and discharge electric potentials of the conductive auxiliary agent and the active material are the same, a charge and discharge capacity of the conductive auxiliary agent can be used effectively in the electrode body. According to this constitution, in a secondary battery using the electrode body, a volume energy density can be improved. Hereinafter, the electrode body in the present embodiment will be described in detail.

### 1-1. Active Material

The active material in the present embodiment is composed of a metal oxide. Hereinafter, the metal oxide used as the active material in the present embodiment will be described.

The metal oxide is not particularly limited as long as it has an electron conductivity, a lithium ion conductivity, and a capacity when oxygen atoms are partially deficient and nitrogen atoms are introduced therein. Examples of the metal oxide include a metal oxide represented by a general formula (1), LiₓM_{y}O₂ (M is a transition metal element, x=0.02 to 2.2, y=1 to 2, and z=1.4 to 4). In the general formula (1), M is preferably one kind or plural kinds selected from the group consisting of Co, Mn, Ni, V, and Fe.

Specific examples of the metal oxide include Li₄Ti₅O₁₂, Li (Ni_{0.5}Mn_{1.5}) O₄, LiCoO₂, LiMnO₂, LiNiO₂, LiVO₂, LiNi_{1/3}CO_{1/3}Mn_{1/3}O₂, LiMn₂O₄, Li₂FeSiO₄, and Li₂MnSiO₄. Among them, Li₄Ti₅O₁₂ and Li (Ni_{0.5}Mn_{1.5}) O₄ are preferably used, for example, and Li₄Ti₅O₁₂ is particularly preferably used. This is because the conductive auxiliary agent obtained by causing a partial deficiency to oxygen atoms in Li₄Ti₅O₁₂ and introducing nitrogen atoms into Li₄Ti₅O₁₂ has a high electron conductivity. As the metal oxide in the present embodiment, other metal oxides such as Li₂FeSiO₄ can be used.

### 1-2. Conductive Auxiliary Agent

The conductive auxiliary agent in the present embodiment is obtained by causing a partial deficiency to oxygen atoms in a metal oxide constituting the active material and introducing nitrogen atoms into the metal oxide. Hereinafter, the conductive auxiliary agent in the present embodiment and a process for producing the conductive auxiliary agent in the present aspect will be described.

### (1) Metal Oxide

The conductive auxiliary agent is obtained by altering a metal oxide constituting the active material. Since the description about the metal oxide overlaps the contents described in the terms “A. Electrode body, 1. First embodiment, 1-1. Active material, and (1) Metal oxide”, the description herein is omitted.

### (2) Deficient Amount of Oxygen Atoms and Introduction Amount of Nitrogen Atoms

The conductive auxiliary agent is obtained by causing a partial deficiency to oxygen atoms in the metal oxide and introducing nitrogen atoms into the metal oxide. Specifically, the conductive auxiliary agent is obtained by causing a partial deficiency to oxygen atoms in the metal oxide and arranging the nitrogen atoms partially at a position where the oxygen atoms are partially deficient. The partially deficient amount of the oxygen atoms and the introduction amount of the nitrogen atoms can be suitably determined on the condition that the conductive auxiliary agent has an electron conductivity, a lithium ion conductivity, and a capacity. When the metal oxide can be represented by the general formula (1), the conductive auxiliary agent can be represented by a general formula (2), LiₓM_{y}O_{z-a}N_{b} (M is a transition metal element, x=0.02 to 2.2, y=1 to 2, z=1.4 to 4, a=deficient amount of oxygen atoms, and b=introduction amount of nitrogen atoms). In the general forma (2), the range of the deficient amount “a” of the oxygen atoms can be suitably determined on the condition that this range is a range in which the electron conductivity of the conductive auxiliary agent is dramatically improved and there is no possibility of collapse of the crystal structure of the metal oxide. Similarly, the range of the introduction amount “b” of the nitrogen atoms can be suitably determined on the condition that this range is a range in which the electron conductivity of the conductive auxiliary agent is dramatically improved and there is no possibility of collapse of the crystal structure of the metal oxide.

When the metal oxide is Li₄Ti₅O₁₂, the conductive auxiliary agent can be represented by a general formula (3) Li₄Ti₅O_{12-c}N_{d} (c=deficient amount of oxygen atoms and d=introduction amount of nitrogen atoms). In the general formula (3), the range of the deficient amount “c” of the oxygen atoms can be suitably determined on the condition that this range is a range in which the electron conductivity of the conductive auxiliary agent is dramatically improved and there is no possibility of collapse of the crystal structure of the metal oxide. Similarly, the range of the introduction amount “d” of the nitrogen atoms can be suitably determined on the condition that this range is a range in which the electron conductivity of the conductive auxiliary agent is dramatically improved and there is no possibility of collapse of the crystal structure of the metal oxide.

### (3) Method of Confirming Deficiency of Oxygen Atoms and Introduction of Nitrogen Atoms

The conductive auxiliary agent is obtained by causing a partial deficiency to oxygen atoms in the metal oxide constituting the active material and introducing nitrogen atoms into the metal oxide. The partial deficiency of the oxygen atoms and the introduction of the nitrogen atoms in the metal oxide can be confirmed by X-ray photoemission spectroscopy (XPS), for example.

### (4) Characteristics of Conductive Auxiliary Agent

It is preferable that the conductive auxiliary agent has a high electron conductivity of 10⁻⁴ S/cm or more, because the electron conductivity of the electrode body can be improved without reducing the performance of the secondary battery using the conductive auxiliary agent in the electrode body. The conductive auxiliary agent has a lithium ion conductivity and a charge and discharge capacity. Thus, when the conductive auxiliary agent is used in the electrode body, in comparison with a case where a conductive auxiliary agent composed of a general carbon-based material is used in an electrode body, a lithium ion conductive path can be prevented from being cut, and the charge and discharge capacity of the electrode body can be improved.

Since the conductive auxiliary agent is obtained by causing a partial deficiency to oxygen atoms in the metal oxide and introducing the nitrogen atoms into the metal oxide, the charge and discharge electric potential of the conductive auxiliary agent is the same as the charge and discharge electric potential of the active material. Accordingly, by virtue of the use of the conductive auxiliary agent and the active material in the electrode body, the charge and discharge capacity of the conductive auxiliary agent can be effectively used in the electrode body.

It is preferable to use the conductive auxiliary agent obtained by causing a partial deficiency to oxygen atoms in Li₄Ti₅O₁₂ and introducing nitrogen atoms into Li₄Ti₅O₁₂. It is preferable that the conductive auxiliary agent, obtained by causing a partial deficiency to oxygen atoms in Li₄Ti₅O₁₂ and introducing nitrogen atoms, has an electron conductivity of 10⁻⁴ S/cm or more at room temperature (25° C.), particularly 10⁻² S/cm or more, and especially 10⁻¹S/cm or more.

### (5) Process for Producing Conductive Auxiliary Agent

The process for producing the conductive auxiliary agent is not particularly limited as long as the conductive auxiliary agent having an electron conductivity, a lithium ion conductivity, and a capacity can be produced by making oxygen atoms partially deficient in the metal oxide and introducing nitrogen atoms into the metal oxide. Specifically, an example of the process for producing the conductive auxiliary agent includes a process for heating the metal oxide under a mixed gas atmosphere composed of ammonia and nitrogen. Even in a process for heating the metal oxide under an atmosphere of ammonia alone, the conductive auxiliary agent can be produced. Meanwhile, as a method of introducing nitrogen atoms into the metal oxide, the metal oxide and urea may be mixed and heated.

When, as a process for producing the conductive auxiliary agent when the metal oxide is Li₄Ti₅O₁₂, a process for heating Li₄Ti₅O₁₂ is used under a mixed gas atmosphere composed of ammonia and nitrogen, although a volume ratio at which ammonia and nitrogen are mixed is not particularly limited as long as the conductive auxiliary agent can be processed, it is preferable that ammonia:nitrogen=1:2 to 1:0.5.

When, as a process for producing the conductive auxiliary agent when the metal oxide is Li₄Ti₅O₁₂, a process for heating Li₄Ti₅O₁₂ is used under a mixed gas atmosphere composed of ammonia and nitrogen, a temperature at which Li₄Ti₅O₁₂ is heated is preferably within a range of 500° C. to 900° C., particularly within a range of 600° C. to 800° C., and especially within a range of 700° C. to 800° C. The temperature is within those ranges, whereby a reaction in which the oxygen atoms are partially deficient in the metal oxide, and the nitrogen atoms are introduced into a position where the oxygen atoms are deficient is easily advanced.

When the metal oxide is Li₄Ti₅O₁₂ and is heated under an atmosphere of ammonia alone, a temperature at which Li₄Ti₅O₁₂ is heated is preferably within a range of 500° C. to 900° C., particularly within a range of 600° C. to 800° C., and especially within a range of 700° C. to 800° C. The temperature is within those ranges, whereby a reaction in which the oxygen atoms are partially deficient in the metal oxide and the nitrogen atoms are introduced into a position where the oxygen atoms are deficient is easily advanced.

In the above method, the time to heat the metal oxide is not particularly limited as long as the conductive auxiliary agent having a high electron conductivity, a lithium ion conductivity, and a capacity can be produced by making oxygen atoms partially deficient in the metal oxide and introducing oxygen atoms into the metal oxide. However, the time to heat the metal oxide is preferably within a temporal range of 0.5 to 20 hours, and particularly within a temporal range of 0.5 to 10 hours. If the time to heat the metal oxide is smaller than the range, the reaction is insufficient. If the time is larger than the range, the crystal structure of the metal oxide may be collapsed.

In the above method, before the metal oxide is heated under a mixed gas atmosphere composed of a reducing gas and a gas for introduction of nitrogen, a pretreatment of heating the metal oxide under an atmosphere of nitrogen gas may be performed. According to this constitution, impurities can be removed from the metal oxide.

### 1-3. Electrode Body

Next, an electrode body in the present embodiment will be described. The electrode body in the present embodiment contains the active material and the conductive auxiliary agent. As the aspect in which the electrode body in the present embodiment contains the active material and the conductive auxiliary agent, three aspects are considered: an aspect (A aspect) in which particles of the active material and particles of the conductive auxiliary agent are mixed, an aspect (B aspect) in which the conductive auxiliary agent is coated on a surface of the particles of the active material, and an aspect (C aspect) in which the surface of the particles of the active material is altered, and the conductive auxiliary agent is formed. Hereinafter, the A aspect, the B aspect, and the C aspect will be described.

### (1) A Aspect

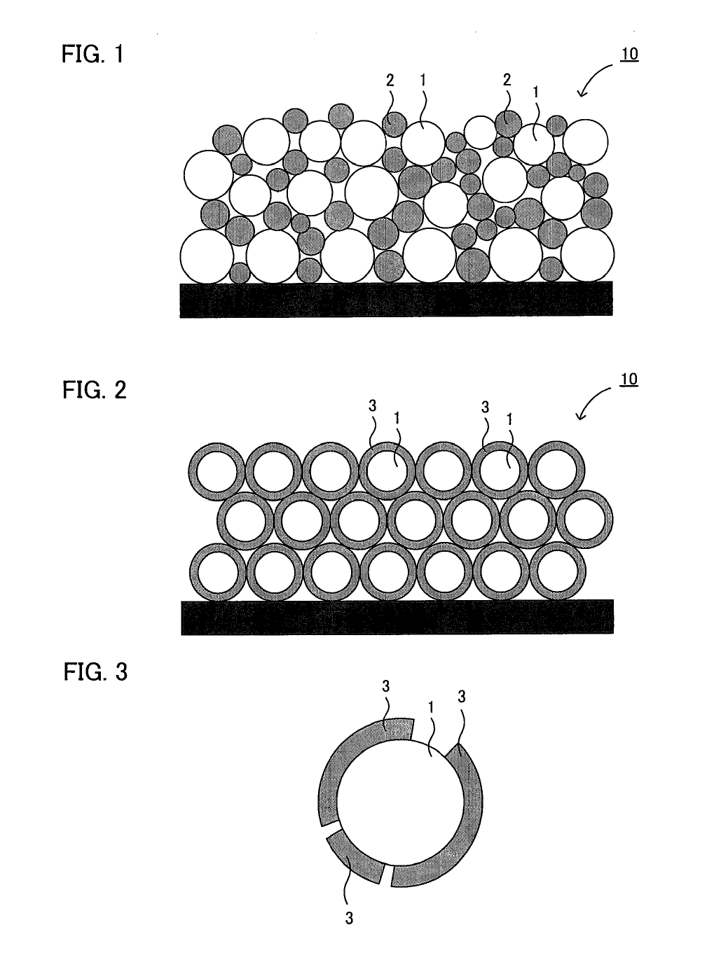

FIG. 1 shows an electrode body 10 having the aspect (A aspect) in which particles 1 of the active material and particles 2 of the conductive auxiliary agent are mixed. In the electrode body in the present aspect, the particle diameter of the particles of the active material is not particularly limited. In the electrode body in the present aspect, although the particle diameter of the particles of the conductive auxiliary agent is not particularly limited, the particle diameter is preferably within a range of 0.1 μm to 5 μm, and particularly within a range of 0.1 μm to 3 μm.

In the electrode body in the present aspect, it is preferable that the particle diameter of the particles of the conductive auxiliary agent is smaller than the particle diameter of the particles of the active material. According to this constitution, each contact area of the active material and the conductive auxiliary agent becomes large, a path of electrons is easily secured, and the electron conductivity of the electrode body becomes large. A gap between the active material and the conductive auxiliary agent becomes small, and the capacity of the electrode body per unit volume can be increased.

### (2) B Aspect

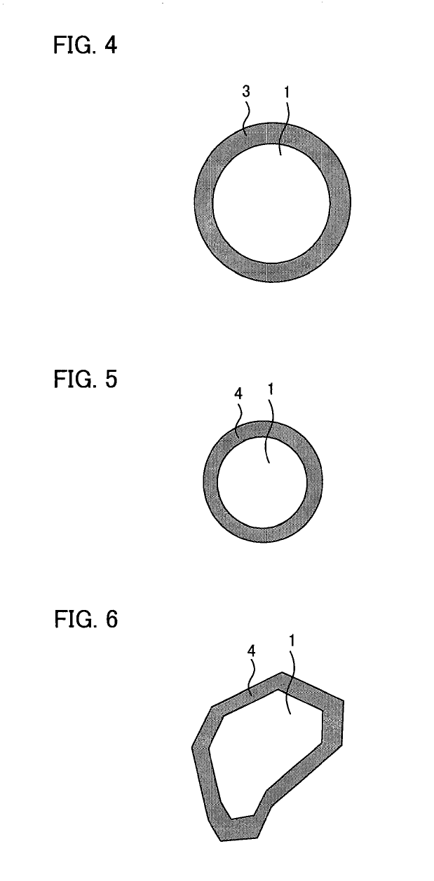

FIG. 2 is a schematic cross-sectional view showing an electrode body 10 having the aspect (B aspect) in which coats 3 of the conductive auxiliary agent are formed on a surface of the particles 1 of the active material. In the electrode body in the present aspect, as shown in FIG. 3, the coats 3 of the conductive auxiliary agent may be formed on some portions of the surface of the particles 1 of the active material, or as shown in FIG. 4, the coat 3 of the conductive auxiliary agent may be formed on the entire surface of the particles 1 of the active material. This is because the conductive auxiliary agent has a lithium ion conductivity, and therefore even if the coat of the conductive auxiliary agent is formed on the entire surface of the particles of the active material, a path for lithium ion conduction is not cut, and the battery performance is not lowered.

In the electrode body in the present aspect, the particle diameter of the particles of the active material can be determined similarly to the particle diameter of the particles of the active material in the A aspect. In the electrode body in the present aspect, the thickness of the coat of the conductive auxiliary agent is not particularly limited.

### (3) C Aspect

FIGS. 5 and 6 are schematic cross-sectional views showing the electrode body having the aspect (C aspect) in which the surface of the particles 1 of the active material is altered to the conductive auxiliary agent to form an alterated layer 4 of the conductive auxiliary agent. The conductive auxiliary agent has a lithium ion conductivity, and therefore even if the alterated layer 4 of the conductive auxiliary agent is formed on the entire surface of the particles 1 of the active material, the path for lithium ion conduction is not cut, and the battery performance is not lowered.

In the electrode body in the present aspect, the particle diameter of the particles 1 of the active material containing the alterated layer 4 can be determined similarly to the particle diameter of the particles of the active material in the A aspect. Further, in the electrode body in the present aspect, the thickness of the alterated layer 4 is not particularly limited.

### 2. Second Embodiment

The electrode body in the present embodiment comprises an active material and a conductive auxiliary agent containing a conductive metal oxide with an electron conductivity of 10⁻⁴ S/cm or more.

According to the present embodiment, since the conductive auxiliary agent contains the conductive metal oxide with a high electron conductivity of 10⁻⁴ S/cm or more, in a secondary battery using the conductive auxiliary agent in the electrode body, the performance can be improved. Hereinafter, the electrode body in the present aspect will be described.

### 2-1. Active Material

The active material in the present embodiment is not particularly limited whether it is a cathode active material or an anode active material. When the active material is a cathode active material, the active material the same as one described in the terms “A. Electrode body, 1. First aspect, and 1-1. Active material” can be used. Further, an olivine-type cathode active material such as LiFePO₄ and LiMnPO₄ may be used other than the metal oxide. When the active material is an anode active material, examples of the active material include a metal active material and a carbon active material. Examples of the metal active material include In, Al, Si, and Sn. Meanwhile, examples of the carbon active material include mesocarbon microbead (MCMB), highly oriented graphite (HOPG), hard carbon, and soft carbon.

### 2-2. Conductive Auxiliary Agent

The conductive auxiliary agent in the present embodiment contains a conductive metal oxide with an electron conductivity of 10⁻⁴ S/cm or more at room temperature (25° C.). Hereinafter, the conductive metal oxide constituting the conductive auxiliary agent will be described.

The conductive metal oxide is not particularly limited as long as the electron conductivity is 10⁻⁴ S/cm or more at room temperature (25° C.). Examples of the conductive metal oxide include one which is obtained by causing a partial deficiency to oxygen atoms in a metal oxide represented by the general formula (1) described in the terms “A. Electrode body, 1. First aspect, and 1-1. Active material” and introducing nitrogen atoms into the metal oxide. Since the modified products of such a metal oxide have been described above, the description herein is omitted.

### 2-3. Electrode Body

The electrode body in the present embodiment comprises the active material and the conductive auxiliary agent. In the present embodiment, it is preferable that the active material is composed of a metal oxide, and the conductive auxiliary agent is composed of the conductive metal oxide obtained by causing a partial deficiency to oxygen atoms in the metal oxide and introducing nitrogen atoms into the metal oxide. Consequently, the respective charge and discharge electric potentials of the conductive auxiliary agent and the active material are the same, and the charge and discharge capacity of the electrode body is increased. Further, in the present embodiment, it is preferable that the active material is composed of Li₄Ti₅O₁₂, and the conductive auxiliary agent is composed of the conductive metal oxide obtained by causing a partial deficiency to oxygen atoms in the Li₄Ti₅O₁₂ and introducing nitrogen atoms into the metal oxide. Consequently, each charge and discharge electric potential of the conductive auxiliary agent and the active material is further increased.

### 3. Usage

It is preferable that the electrode body of the present invention is used in a lithium secondary battery. The electrode body of the present invention can be used both in cathode and anode in the lithium secondary battery.

### B. Conductive Auxiliary Agent for Secondary Battery

Next, a conductive auxiliary agent for secondary battery of the present invention will be described. The conductive auxiliary agent for secondary battery is obtained by causing a partial deficiency to oxygen atoms in Li₄Ti₅O₁₂ and introducing nitrogen atoms into Li₄Ti₅O₁₂, and has an electron conductive of 10⁻⁴ S/cm or more. Hereinafter, a conductive auxiliary agent for secondary battery and a process for producing the conductive auxiliary agent for secondary battery according to the present invention will be described.

According to the present invention, Li₄Ti₅O₁₂ as a raw material of the conductive auxiliary agent for secondary battery is generally used as an active material in the electrode body and has a lithium ion conductivity and a capacity. Thus, the conductive auxiliary agent for secondary battery containing partially deficient oxygen atoms in Li₄Ti₅O₁₂ and obtained by introducing nitrogen atoms into Li₄Ti₅O₁₂ has a high electron conductivity of 10⁻⁴ S/cm or more at room temperature (25° C.), a lithium ion conductivity, and a capacity.

Since the details of the modified products of Li₄Ti₅O₁₂ have been described in the terms “A. Electrode body and 1-2. Conductive auxiliary agent”, the description herein is omitted.

### C. Secondary Battery

Next, a secondary battery of the present invention will be described. In the secondary battery of the present invention, at least one of a cathode layer and an anode layer is formed of the electrode body described in the term “A. Electrode body”.

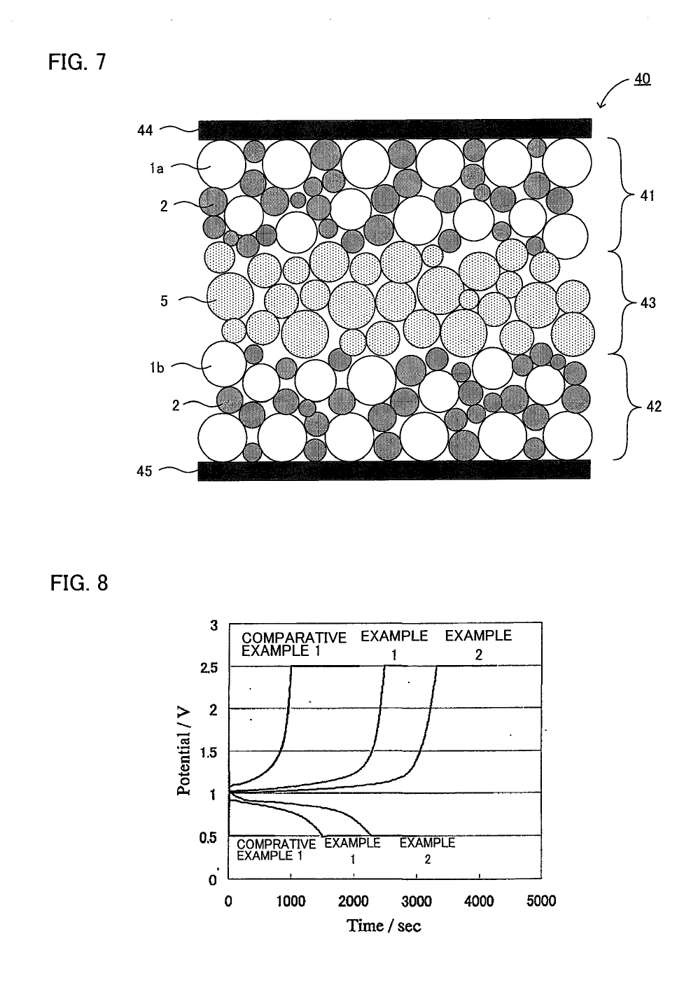

FIG. 7 is a schematic cross-sectional view showing an example of the secondary battery of the present invention. A secondary battery 40 shown in FIG. 7 comprises a cathode layer 41, an anode layer 42, and an electrolyte layer 43 provided between the cathode layer and the anode layer. The secondary battery 40 further comprises a cathode layer current collector 44 which performs current collection of the cathode layer 41 and an anode layer current collector 45 which performs current collection of the anode layer 42. The cathode layer 41 has particles la of a cathode active material and the particles 2 of the conductive auxiliary agent. The anode layer 42 has particles lb of an anode active material and the particles 2 of conductive auxiliary agent. The electrolyte layer 43 has particles 5 of the electrolyte. Hereinafter, the secondary battery will be described.

### 1. Anode Layer and Cathode Layer

First, the anode layer and the cathode layer of the present invention will be described. In the present invention, at least one of the anode layer and the cathode layer is constituted of the electrode body described in the term “A. Electrode body”. Both the anode layer and the cathode layer may be constituted of the electrode body described in the term “A. Electrode body”. When only one of the anode layer and the cathode layer is constituted of the electrode body described in the term “A. Electrode body”, the other electrode body may use a generally used anode layer or cathode layer.

When the secondary battery of the present invention is an all-solid-state secondary battery, the electrode body constituting the anode layer and the cathode layer may further contain a solid electrolyte. Although the solid electrolyte is not particularly limited as long as it has a lithium ion conductivity, an oxide solid electrolyte and a sulfide solid electrolyte may be used. In the present invention, it is particularly preferable that the solid electrolyte is the sulfide solid electrolyte. This is because the sulfide solid electrolyte has a high lithium ion conductivity, and each lithium ion conductivity of the anode layer and the cathode layer can be improved. Examples of the sulfide solid electrolyte include Li₇P₃S₁₁.

The anode layer and the cathode layer may contain a binder material. The kinds of the binder material used in the present invention include a fluorine-containing binder material. The thickness of the anode layer and the cathode layer is preferably within a range of 0.1 μm to 1000 μm, for example.

### 2. Electrolyte Layer

Next, the electrolyte layer will be described. The electrolyte layer used in the present invention is formed between the cathode layer and the anode layer. Although the electrolyte layer is not particularly limited as long as lithium ion conduction can be performed, it is preferably a solid electrolyte layer, whereby a high-security all-solid-state secondary battery can be obtained. The thickness of the solid electrolyte layer is preferably within a range of 0.1 μm to 1000 μm, for example, and particularly within a range of 0.1 μm to 300 μm. Examples of a method of the solid electrolyte layer formation include a method of compression-molding a solid electrolyte material. As the solid electrolyte used in the solid electrolyte layer, a solid electrolyte the same as one described in the terms “C. Secondary battery and 1. Anode layer and cathode electrode layer” can be used.

### 3. Other Configuration

The secondary battery comprises at least the cathode layer, the electrolyte layer, and the anode layer. The secondary battery usually further has a cathode layer current collector which performs current collection of the cathode layer and an anode layer current collector which performs current collection of the anode layer. The cathode layer current collector may be formed of SUS, aluminum, nickel, iron, titanium, and carbon, and SUS is particularly used. Meanwhile, the anode layer current collector may be formed of SUS, copper, nickel, and carbon, and SUS is particularly used. It is preferable that the thickness and shape of the cathode layer current collector and the anode layer current collector are suitably selected according to factors such as the usage of the secondary battery. As a battery case used in the present invention, a general secondary battery case can be used. Further, as the battery case, a battery case made of SUS may be used, for example. When the secondary battery of the present invention is an all-solid-state battery, the secondary battery may be provided in an insulating ring.

### 4. Secondary Battery

The secondary battery of the present invention is usable as an in-vehicle battery, for example. The secondary battery of the present invention may have a coin shape, a laminate shape, a cylindrical shape, and a square shape.

The method of manufacturing a secondary battery of the present invention is not particularly limited as long as the secondary battery described above can be obtained, and a method similar to a general method of manufacturing a secondary battery can be used. For example, when the secondary battery of the present invention is an all-solid-state battery, as an example of the manufacturing method, a material constituting a cathode layer, a material constituting a solid electrolyte layer, and a material constituting an anode layer are pressed sequentially to thereby manufacture the secondary battery; the secondary battery is contained in a battery case; and the battery case is caulked, can be cited.

### EXAMPLES

Hereinafter, the present invention will be more specifically described by way of examples.

### Example 1

There manufactured an all-solid-state secondary battery constituted of : a cathode layer produced by mixing Li₄Ti₅O₁₂ (8.2 mg) as an active material, Li₄Ti₅O₁₂₋ₓN_{y} (3.28 mg) as a conductive auxiliary agent, and 75Li₂S-25P₂S₅ (4.92 mg) as an electrolyte; an electrolyte layer produced from 75Li₂S-25P₂S₅, and an anode layer produced from In—Li. Li₄Ti₅O₁₂₋ₓN_{y} as a raw material of the cathode layer is obtained by heating Li₄Ti₅O₁₂ in N₂ gas and then heating Li₄Ti₅O₁₂ in a mixed gas composed of N₂ gas and NH₃ gas. The marks “x” and “y” in Li₄Ti₅O₁₂₋ₓN_{y} represent the deficient amount of oxygen atoms and the introduction amount of nitrogen atoms, respectively.

### Example 2

An all-solid-state secondary battery is manufactured in exactly the same way as the example 1 except that the cathode layer is produced by mixing Li₄Ti₅O₁₂ (6.56 mg), Li₄Ti₅O₁₂₋ₓN_{y} (4.92 mg) as a conductive auxiliary agent, and 75Li₂S-25P₂S₅ (4.92 mg). The respective particle diameters of Li₄Ti₅O₁₂, Li₄Ti₅O₁₂₋ₓN_{y}, and 75Li₂S-25P₂S₅ are the same as the particle diameters used in the example 1.

### Comparative example 1

An all-solid-state secondary battery is manufactured in exactly the same way as the example 1 except that the cathode layer is produced by mixing Li₄Ti₅O₁₂ (11.48 mg) and 75Li₂S-25P₂S₅ (4.92 mg). The respective particle diameters of Li₄Ti₅O₁₂ and 75Li₂S-25P₂S₅ are the same as the particle diameters used in the example 1.

### Evaluation 1

### (Evaluation of Charge and Discharge Characteristics)

Charging and discharging (electric potential region 0.5 V to 2.5 V) are performed at a current density of 0.1 C, and the charge and discharge characteristics are evaluated. The results of the evaluation of the charge and discharge characteristics of the all-solid-state rechargeable batteries manufactured in the examples 1 and 2 and the comparative example 1 are shown in FIG. 8.

As shown in FIG. 8, discharging cannot be confirmed in the all-solid-state secondary battery of the comparative example 1. Meanwhile, discharging can be confirmed in the all-solid-state secondary batteries of the examples 1 and 2. This is because it is considered that the cathode layers of the all-solid-state secondary batteries of the examples 1 and 2 contain Li₄Ti₅O₁₂₋ₓN_{y} having an electron conductivity and functioning as a conductive auxiliary agent.

### Example 3

### (Raw Material Pretreatment)

Li₄Ti₅O₁₂ (30 g) is held in N₂ gas (1 L/min) at 800° C. for 10 hours. After that, heating is terminated, and natural cooling is performed. The particle diameter of Li₄Ti₅O₁₂ is the same as the particle diameter used in the example 1.

### (Calcination Treatment)

Li₄Ti₅O₁₂ (30 g) subjected to pretreatment is held at 800° C. for 10 hours again while N₂ gas (1 L/min) and NH₃ gas (1 L/min) are flowed. After that, heating is terminated, and natural cooling is performed. Consequently, the target sample is obtained.

### Example 4

A sample is obtained similarly to the example 3 except that the raw material pretreatment is not performed.

### Comparative example 2

Li₄Ti₅O₁₂ (30 g) is used as it is as a sample. The particle diameter of Li₄Ti₅O₁₂ is the same as the particle diameter of one used in the example 1.

### Evaluation 2

### (X-Ray Diffraction Measurement)

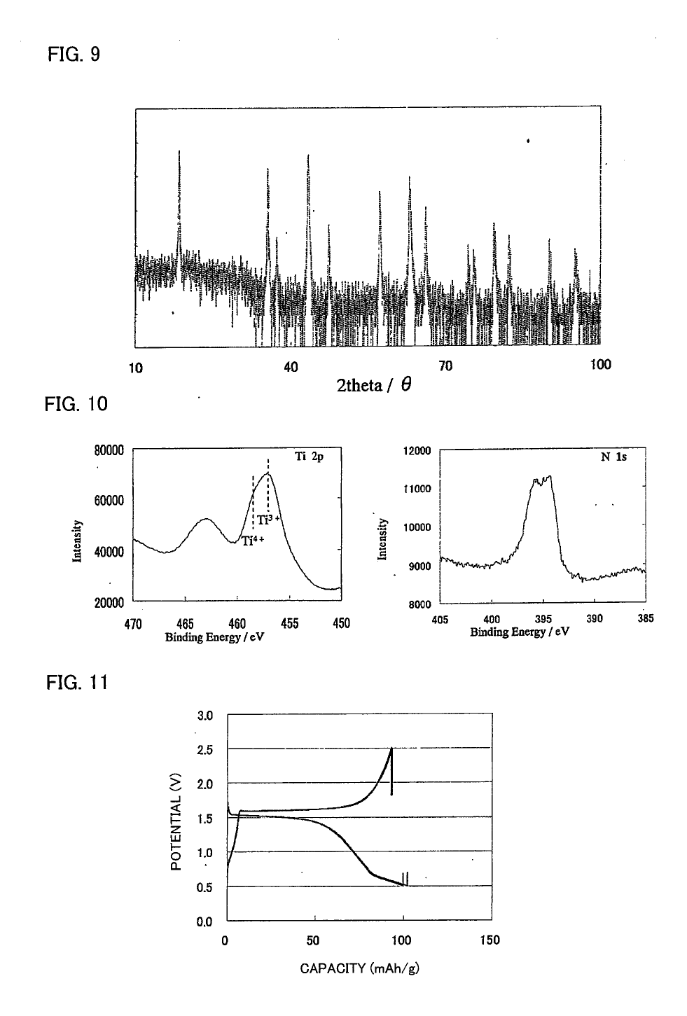

X-ray diffraction measurement of the sample obtained in the example 3 is performed. The results of the x-ray diffraction measurement of the sample obtained in the example 3 are shown in FIG. 9. An x-ray diffraction spectrum of the sample obtained in the example 3 is the same as the x-ray diffraction spectrum of Li₄Ti₅O₁₂ obtained in the comparative example 2.

### (X-Ray Photoemission Spectroscopy Measurement)

X-ray photoemission spectroscopy measurement of the sample obtained in the example 3 is performed. The results of the x-ray photoemission spectroscopy measurement of the sample obtained in the example 3 are shown in FIG. 10. As shown in FIG. 10, in Ti2p spectrum measurement, Ti⁴⁺ derived from Li₄Ti₅O₁₂ and Ti³⁺ derived from an oxygen atom deficiency are detected. As shown in FIG. 10, in N1s spectrum measurement, since a peak appears at 400 eV or less, it turns out that nitrogen is not surface-adsorbed but contained in a structure.

### (Evaluation of Electron Conductivity)

The samples of approximately 1 g obtained in the examples 3 and 4 are introduced into a tubular body with four probes installed on the bottom surface and subjected to application of a pressure of 20 kN, and resistance measurement is performed at room temperature (25° C.). An electric conductivity at room temperature (25° C.) is calculated from the obtained resistance value. The results of the evaluation of the electron conductivity of the samples obtained in the examples 3 and 4 are shown in a table 1.

TABLE 1

| | | Electric | |
|---|---|---|---|
| | Resistance | conductivity | |
| | (Ω) | (S/cm) | Density (g/cc) |
| Example 3 | 58.39 | 3.48 × 10⁻² | 2.357 |
| Example 4 | 6.827 | 3.425 × 10⁻¹ | 2.661 |

Although the electric conductivity of Li₄Ti₅O₁₂ obtained in the comparative example 2 is to be calculated similarly to the samples obtained in the examples 3 and 4, only a sample with an electric conductivity of 1.0×10⁻⁷ (S/cm) or more can be measured by the measurement device used in this evaluation, and therefore, the electric conductivity of Li₄Ti₅O₁₂ cannot be calculated accurately. However, since the measurement cannot be performed, the electric conductivity of Li₄Ti₅O₁₂ is considered to be less than 1.0×10⁻⁷ (S/cm).

### (Evaluation of Charge and Discharge Characteristics)

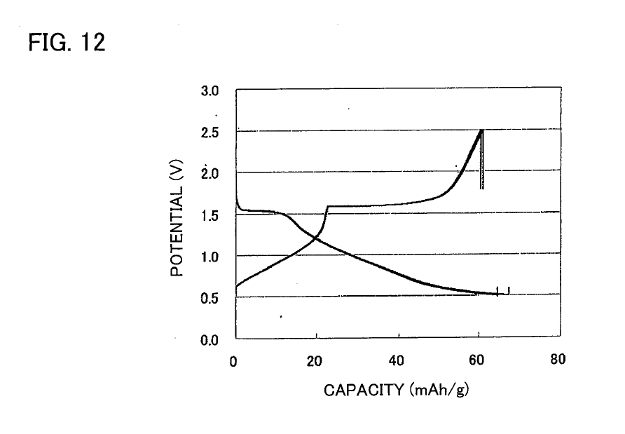

An all-solid-state secondary battery is produced from: a cathode layer produced by mixing Li₄Ti₅O₁₂ as an active material, the sample obtained in the example 3, carbon (HS100) as a conductive auxiliary agent, and a binder (PTFE); an electrolyte layer (PST3); and an anode layer (Pt foil). Similarly, an all-solid-state secondary battery is produced from: a cathode layer produced by mixing Li₄Ti₅O₁₂ as an active material, the sample obtained in the example 4, carbon (HS100) as a conductive auxiliary agent, and a binder (PTFE); an electrolyte layer (DST3); and an anode layer (Pt foil). In those all-solid-state secondary batteries, charging and discharging (electric potential region 0.5 V to 2.5 V) are performed at a current density of 0.2 mA/cm², and the charge and discharge characteristics are evaluated. The results of the evaluation of the charge and discharge characteristics of the all-solid-state secondary battery produced from the sample of the example 3 and the all-solid-state secondary battery produced from the sample of the example 4 are shown in FIGS. 11 and 12, respectively.

The discharge capacity of the all-solid-state secondary battery produced from the sample of the example 3 is reduced to 80 mAh/g or less relative to a theoretical discharge capacity of 175 mAh/g of the all-solid-state secondary battery produced from Li₄Ti₅O₁₂ of the comparative example 2. The discharge capacity of the all-solid-state secondary battery produced from the sample of the example 4 is reduced to 60 mAh/g or less relative to the theoretical discharge capacity of 175 mAh/g of the all-solid-state secondary battery produced from Li₄Ti₅O₁₂ of the comparative example 2.

Hereinafter, the confirmed facts of the present evaluation will be described. Since the x-ray diffraction spectrum of the sample of the example 3 is the same as the x-ray diffraction spectrum of Li₄Ti₅O₁₂ of the comparative example 2, it cannot be confirmed that the crystal structure of the sample of the example 3 is changed relative to the crystal structure of Li₄Ti₅O₁₂ of the comparative example 2.

The results of the x-ray photoelectron spectroscopy measurement show that the sample obtained in the example 3 contains deficient oxygen atoms in Li₄Ti₅O₁₂ and further contains nitrogen atoms in its structure.

It is confirmed from the results of the evaluation of the electron conductivity that the electron conductivity in the samples obtained in the examples 3 and 4 is high in comparison with Li₄Ti₅O₁₂ of the comparative example 2. The electron conductivity in the samples obtained in the examples 3 and 4 is confirmed to be 10⁻⁴ S/cm or more at room temperature (25° C.). Further, it is confirmed from the results of the charge and discharge characteristics that the charge and discharge capacities in the samples obtained in the examples 3 and 4 is reduced in comparison with Li₄Ti₅O₁₂ of the comparative example 2.

According to the above constitutions, it is confirmed that the conductive auxiliary agent having an electron conductivity and charge and discharge capacities is obtained by making oxygen atoms deficient in Li₄Ti₅O₁₂ and containing nitrogen in the structure.

### REFERENCE SIGNS LIST

1 Particles of active material
1a Particles of cathode active material
1b Particles of anode active material
2 Particles of conductive auxiliary agent
3 Coat of conductive auxiliary agent
4 Alterated layer of conductive auxiliary agent
5 Particles of electrolyte
10 Electrode body
40 Secondary battery
41 Cathode layer
42 Anode layer
43 Electrolyte layer
44 Cathode layer current collector
45 Anode layer current collector

1. An electrode body comprising:
an active material composed of a metal oxide; and
a conductive auxiliary agent obtained by causing a partial deficiency to an oxygen atom in the metal oxide and introducing a nitrogen atom into the metal oxide.

2. An electrode body comprising:
an active material; and
a conductive auxiliary agent composed of a conductive metal oxide having an electron conductivity of 10⁻⁴ S/cm or more and a charge and discharge capacity.

3. The electrode body according to claim 2, wherein the active material is composed of a metal oxide, and the conductive metal oxide is obtained by causing a partial deficiency to an oxygen atom in the metal oxide and introducing a nitrogen atom into the metal oxide.

4. The electrode body according to claim 1, wherein the metal oxide is Li₄Ti₅O₁₂.

5. A conductive auxiliary agent for a secondary battery, obtained by removing a part of an oxygen atom in Li₄Ti₅O₁₂ and introducing a nitrogen atom into Li₄Ti₅O₁₂, and having an electron conductivity of 10⁻⁴ S/cm or more.

6. A secondary battery, comprising the electrode body according to used in at least one of a cathode layer and an anode layer.

7. A secondary battery, comprising the electrode body according to claim 2 used in at least one of a cathode layer and an anode layer.

8. The electrode body according to claim 3, wherein the metal oxide is Li₄Ti₅O₁₂.
